(19) United States
(12) Patent Application Publication
(10) Pub. No.: US 2020/0012926 A1
(43) Pub. Date: Jan. 9, 2020

(54) NEURAL NETWORK LEARNING DEVICE AND NEURAL NETWORK LEARNING METHOD

(71) Applicant: HITACHI, LTD., Tokyo (JP)

(72) Inventor: Daichi MURATA, Tokyo (JP)

(73) Assignee: HITACHI, LTD., Tokyo (JP)

(21) Appl. No.: 16/460,382

(22) Filed: Jul. 2, 2019

(30) Foreign Application Priority Data
Jul. 5, 2018 (JP) 2018-128241

(51) Int. Cl. G06N 3/063; G06N 3/04

(52) U.S. Cl. CPC G06N 3/063; G06N 3/04

(57) ABSTRACT

Provided is a learning device of a neural network including a bitwidth reducing unit, a learning unit, and a memory. The bitwidth reducing unit executes a first quantization that applies a first quantization area to a numerical value to be calculated in a neural network model. The learning unit performs learning with respect to the neural network model to which the first quantization has been executed. The bitwidth reducing unit executes a second quantization that applies a second quantization area to a numerical value to be calculated in the neural network model on which learning has been performed in the learning unit. The memory stores the neural network model to which the second quantization has been executed.

### BACKGROUND OF THE INVENTION

### 1. Field of the Invention

The present invention is a technique related to learning of a neural network. A preferable application example is a technique related to learning of AI (Artificial Intelligence) using deep learning.

### 2. Description of the Related Art

In the brain of an organism, a large number of neurons are present, and each neuron performs a signal input from many other neurons and a movement to output a signal to many other neurons. It is a neural network such as Deep Neural Network (DNN) that attempts to realize such a brain mechanism with a computer, and is an engineering model that mimics the behavior of a biological neural network. As an example of DNN, there is a Convolutional Neural Network (CNN) effective for object recognition and image processing.

FIG. 1 shows an example of the configuration of CNN. The CNN comprises an input layer 1, one or more intermediate layers 2, and a multilayer convolution operation layer called an output layer 3. In the N-th layer convolutional operation layer, the value output from the (N−1)-th layer is used as an input, and a weight filter 4 is convoluted with this input value to output the obtained result to the input of the (N+1)-th layer. At this time, it is possible to obtain high generalization performance by setting (learning) the kernel coefficient (weighting factor) of the weight filter 4 to an appropriate value according to the application.

In recent years, CNN has been applied to automatic driving, and motions for realizing object recognition, action prediction, and the like have been accelerated. However, in general, CNN has a large amount of calculation, and in order to be mounted on an on-vehicle ECU (Electronic Control Unit) or the like, it is necessary to reduce the weight of CNN. One of the ways to reduce the weight of CNN is bitwidth reduction of operation. Qiu et al. Going Deeper with Embedded FPGA Platform for Convolutional Neural Network. FPGA'16 describes a technology for realizing CNN by low bitwidth operation.

### SUMMARY OF THE INVENTION

In Qiu et al. Going Deeper with Embedded FPGA Platform for Convolutional Neural Network, FPGA'16, a sampling area (quantization area) for bitwidth reduction is set according to the distribution of weighting factors and feature maps for each layer. However, changes in the distribution of weighting factors and feature maps due to relearning after bitwidth reduction are not considered. Therefore, there is a problem that information loss due to overflow occurs when the distribution of weighting factors and feature maps changes during relearning and deviates from the sampling area set in advance for each layer.

The above-mentioned problem which inventors examined is explained in detail in FIGS. 2A-2C. As is well known, in a typical example of CNN learning, relearning is repeatedly performed to correct weighting factors based on the degree of coincidence between the output and the correct answer for each input of learning data. Then, the final weighting factor is set so as to minimize the loss function (learning loss).

FIGS. 2A-2C shows how the distribution of weighting factors changes due to repeated relearning. The horizontal axis is the value of the weighting factor, and the vertical axis is the distribution of the weighting factors. The initial weighting factor is a continuous value or high-bitwidth information as shown in FIG. 2A. Here, as shown in FIG. 2B, sampling areas covering the maximum value and the minimum value of the weighting factor are set, and sampling areas are sampled at equal intervals, for example, into 2ⁿ. The sampling process converts high-bitwidth information into low-bitwidth information, thereby reducing the amount of calculation.

As described above, in the weighting factor learning process, the weighting factor is optimized by repeating relearning. At this time, when learning is performed again using, the weighting factor that has been reduced in bitwidth, the weighting factor changes, and the distribution of the weighting factors also changes as shown in FIG. 2C. Then, there may be a situation (overflow) in which the weighting factor deviates from the sampling area set before relearning. In FIG. 2C, the data in the overflowed part is lost or compressed to the maximum value or the minimum value of the sampling area. Thus, overflow may reduce the accuracy of learning.

Therefore, an object of the present invention is to enable appropriate calculation while reducing the weight of CNN by bitwidth reduction of operation.

A preferred aspect of the present invention is a neural network learning device including a bitwidth reducing unit, a learning unit, and a memory. The bitwidth reducing unit executes a first quantization that applies a first quantization area to a numerical value to be calculated in a neural network model. The learning unit performs learning with respect to the neural network model to which the first quantization has been executed. The bitwidth reducing unit executes a second quantization that applies a second quantization area to a numerical value to be calculated in the neural network model on which learning has been performed in the learning unit. The memory stores the neural network model to which the second quantization has been executed.

Another preferable aspect of the present invention is a neural network learning method that learns a weighting factor of a neural network by an information processing apparatus including a bitwidth reducing unit, a learning unit, and a memory. This method includes a first step of executing, by the bitwidth reducing unit, a first quantization that applies a first quantization area to a weighting factor of an arbitrary neural network model that has been input; a second step of performing, by the learning unit, learning with respect to the neural network model to which the first quantization has been executed; a third step of executing, by the bitwidth reducing unit, a second quantization that applies a second quantization area to a weighting factor of the neural network model on which the learning has been performed in the learning unit; and a fourth step of storing, by the memory, the neural network model to which the second quantization has been executed.

According to the present invention, it is possible to perform appropriate calculation while reducing the weight of CNN by bitwidth reduction of operation.

### BRIEF DESCRIPTION OF THE DRAWINGS

FIG. 1 is a conceptual diagram of an example of a CNN structure;

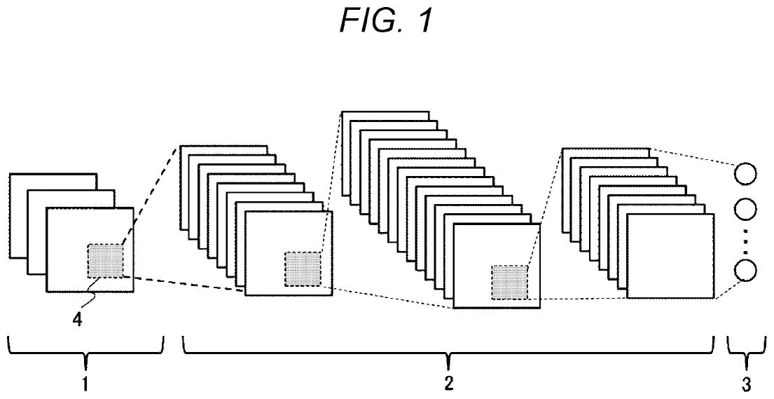

FIGS. 2A-2C are a conceptual diagram of a bitwidth reduction sampling method according to a comparative example;

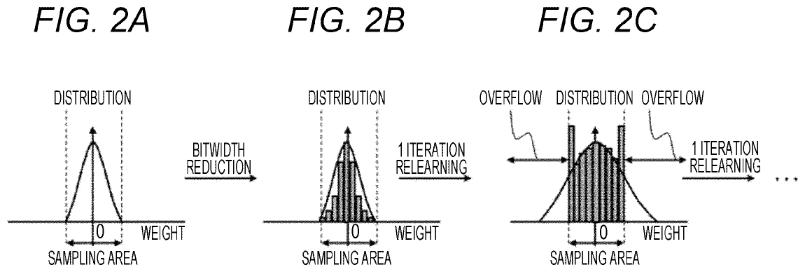

FIGS. 3A-3C are a conceptual diagram of a bitwidth reduction sampling method according to an embodiment;

FIG. 4 is a block diagram of a device according to a first embodiment;

FIG. 5 is a flowchart in the first embodiment;

FIG. 6 is a block diagram of a device according to a second embodiment;

FIG. 7 is a flowchart in the second embodiment;

FIG. 8 is a block diagram of a device according to a third embodiment;

FIG. 9 is a flowchart in the third embodiment; and

FIG. 10 is a graph showing an effect of applying the present invention to ResNet34.

### DESCRIPTION OF THE PREFERRED EMBODIMENTS

An embodiment will be described below with reference to the drawings. However, the present invention should not be construed as being limited to the description of the embodiments shown below. Those skilled in the art can easily understand that specific configurations can be changed in a range not departing from the spirit or gist of the present invention.

In the configuration of the invention described below, the same portions or portions having similar functions are denoted by the same reference numerals in different drawings, and redundant description may be omitted. In the case where there are a plurality of elements having the same or similar functions, the same reference numerals may be described with different subscripts. However, in the case where it is not necessary to distinguish a plurality of elements, subscripts may be omitted and described.

In the present specification and the like, the expressions “first”, “second”, “third” and the like are used to identify the constituent elements and do not necessarily limit the number, order, or contents thereof. The number for identifying components is used for each context, and the number used in one context does not necessarily indicate the same configuration in another context. In addition, it does not prevent that the component identified by a certain number doubles as the function of the component identified by another number.

The positions, sizes, shapes, ranges, and the like of the components shown in the drawings and the like may not represent actual positions, sizes, shapes, ranges, and the like in order to facilitate understanding of the invention. For this reason, the present invention is not necessarily limited to the position, size, shape, range, etc. disclosed in the drawings and the like.

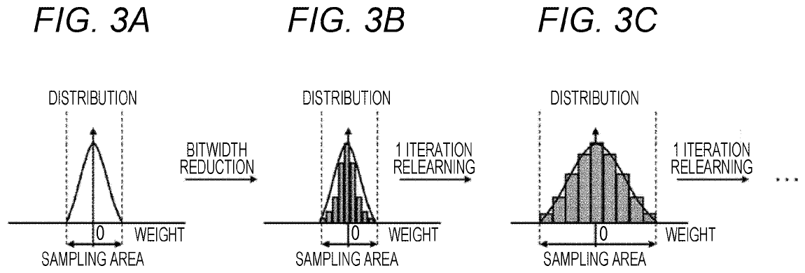

FIGS. 3A-3C conceptually illustrates an example of the embodiment described in detail below. In the embodiment, while the weight of the CNN is reduced by bitwidth reduction of the numerical value to be calculated, the information loss due to deviation of the numerical value to be calculated from the sampling area is suppressed. Specific examples of the numerical values to be calculated include a weighting factor of a neural network model, an object to which the weighting factor is to be convoluted, and a feature map that is the result of the convolution. In the following, the weighting factor is mainly described as an example. The initial weighting factor is a continuous value or high-bitwidth information as shown in FIG. 3A. Here, as shown in FIG. 3B, sampling areas covering the maximum value and the minimum value of the weighting factor are set, and sampling areas are sampled at equal intervals, for example, into 2ⁿ. The sampling process converts high-bitwidth information into low-bitwidth information, thereby reducing the amount of calculation.

In this embodiment, the sampling area of the weighting factor is dynamically changed according to the change of the weighting factor during relearning after bitwidth reduction in (B). Dynamic change of the sampling area reduces bitwidth while preventing overflow. Specifically, each time 1 iteration (one iteration) relearning is performed, the weighting factor distribution for each layer is summed up, and a range between the maximum value and the minimum value of the weighting factors is reset as a sampling area. Thereafter, as shown in FIG. 3C, bitwidth reduction is performed by requantizing the reset sampling area at equal intervals. The above is an example of the quantization process for the weighting factor, but the same quantization process can be performed also on the numerical value of the feature map with which the weighting factor is product-sum operated.

The process described in FIGS. 3A-3C is performed, for example, for each layer of the CNN to enable appropriate quantization to avoid overflow for each layer. However, it may be performed collectively for multiple layers, or may be performed for each edge of one layer. By using this method, even when the distribution of the weighting factors and the feature maps changes during relearning, the occurrence of the overflow can be suppressed, so that it is possible to prevent the loss of the information amount. As a result, in CNN, it is possible to reduce the bitwidth of the CNN operation while suppressing the decrease in recognition accuracy.

### First Embodiment

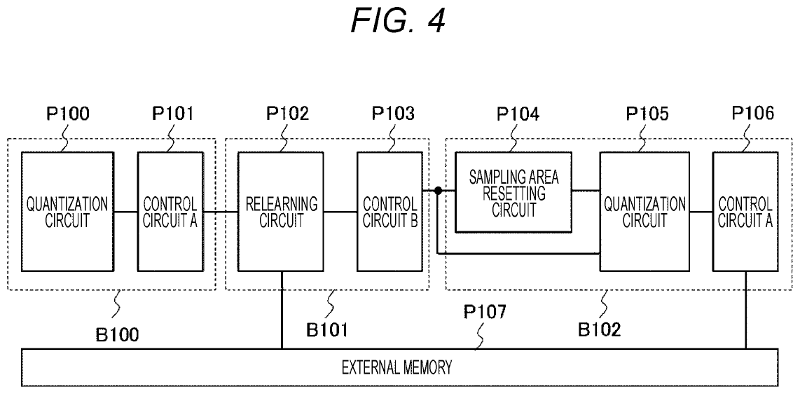

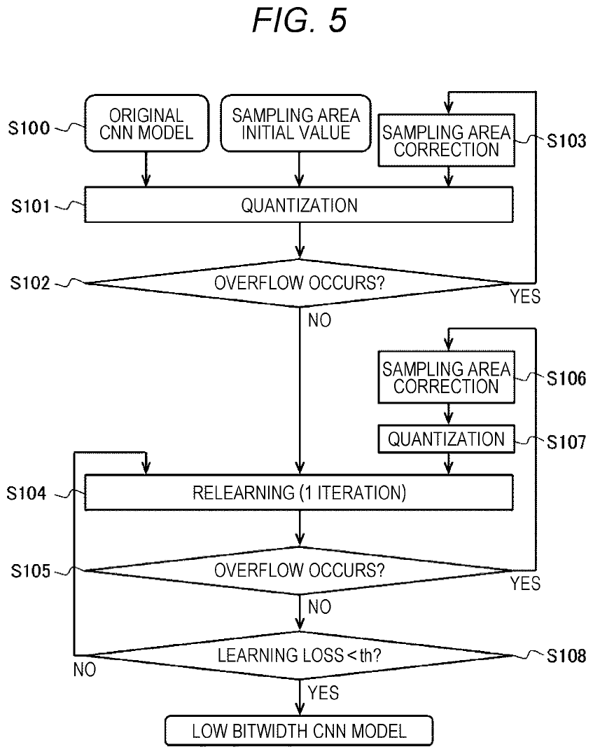

FIG. 4 and FIG. 5 are a block diagram and a processing flowchart of a first embodiment, respectively. The learning process of the weighting factor of the CNN model will be described with reference to FIGS. 4 and 5. In this embodiment the configuration of the learning device of the neural network shown in FIG. 4 is realized by a general information processing apparatus (computer or server) including a processing device, a storage device, an input device, and an output device. Specifically, a program stored in the storage device is executed by the processing device to realize the functions such as calculation and control in cooperation with other hardware for the determined processing. The program executed by the information processing apparatus, the function thereof, or the means for realizing the function may be referred to as “function”, “means”, “unit”, “circuit” or the like.

The configuration of the information processing apparatus may be configured by a single computer, or any part of the input device, the output device, the processing device, and the storage device may be configured by another computer connected by a network. Also, functions equivalent to the functions configured by software can be realized by hardware such as a field programmable gate array (FPGA) or an application specific integrated circuit (ASIC). Such an embodiment is also included in the scope of the present invention.

The configuration shown in FIG. 4 includes a bitwidth reducing unit (B100) that receives an arbitrary CNN model as an input and samples the weighting factor of the CNN model without overflow. The configuration further includes a relearning unit (B101) that relearns a bitwidth-reduced CNN model and a bitwidth re-reducing, unit (B102) that if the distribution of weighting factors changes during relearning, corrects the sampling area so that overflow does not occur, and reduces the bitwidth again. The relearning unit (B101) may apply a general neural network learning device (learning unit).

The operation based on the flowchart of FIG. 5 will be described below. Incidentally, in FIG. 5, the step representing the process is abbreviated as S.

Step 100: As inputs, an original CNN model before bitwidth reduction and a sampling area initial value for performing low bitwidth quantization of the weighting factor of the original CNN model are provided. The sampling area initial value may be a random value or a preset fixed value.

Step 101: Based on the sampling area initial value, the weighting factor of the original CNN model is low-bitwidth quantized by a quantization circuit (P100) to generate a low-bitwidth quantized CNN model. In a specific example, when low bitwidth quantization is performed on n bits, quantization is performed by dividing the sampling area into 2ⁿ areas at equal intervals.

Step 102: A control circuit A (P101) determines whether the weighting factor of the low-bitwidth quantized CNN model deviates from the sampling area initial value (overflow). If an overflow occurs, the process proceeds to step 103. If an overflow does not occur, the low-bitwidth quantized CNN model is used as a low bitwidth model without overflow, and the process proceeds to step 104.

Step 103: If an overflow occurs, the sampling area is corrected so as to expand by a predetermined value, and low bitwidth quantization of the weight parameter is performed again by the quantization circuit (P100). Thereafter, the process returns to step 102 to determine again whether or not the weighting factor has overflowed.

Step 104: In a relearning circuit (P102), 1 iteration relearning is performed for the low-bitwidth model without overflow. In the present embodiment, the CNN learning itself may follow the prior art.

Step 105: If the distribution of weighting factors changes due to relearning, a control circuit A (P106) determines whether the weighting factors have overflowed in the sampling area set in step 103. If an overflow occurs, the process proceeds to step 106. If an overflow does not occur, the process proceeds to step 108.

Step 106: If it is determined in step 105 that an overflow will occur, a sampling area resetting circuit (P104) corrects the sampling area again so as to expand it and prevents the overflow from occurring.

Step 107: A quantization circuit (P105) performs quantization again based on the sampling area set in step 106, thereby generating a bitwidth-reduced CNN model without overflow. Specifically, when low bitwidth quantization is performed on n bits, quantization is performed by dividing the sampling area into 2ⁿ areas at equal intervals.

Step 108: If the learning loss indicated by the loss function at the time of learning the bitwidth-reduced CNN model without overflow generated in step 107 is less than a threshold th, the processing is terminated and output as a low bitwidth CNN model. On the contrary, if it is equal to or more than the threshold, the process returns to step 104 and the relearning process is continued. This determination is performed by a control circuit B (P103). The output low bitwidth CNN model or the low bitwidth CNN model during relearning is stored in an external memory (P107).

By the above processing, even when the weighting factor changes due to relearning, it is possible to reduce the bitwidth of information while avoiding overflow. In the above example, the presence or absence of an overflow is checked, and the sampling area is corrected when an overflow occurs. However, the checking of the presence or absence of the overflow may be omitted, and the sampling area may be always updated every relearning. Alternatively, without limiting to the overflow, the sampling area may be updated upon change of the distribution of weighting factors. By setting the sampling area to cover the maximum value and the minimum value and performing requantization regardless of the overflow, it is possible to set an appropriate sampling area even if the sampling area is too wide. Also, in FIG. 4, although the quantization circuits (P100 and P105) and the control circuits A (P101 and P106) are shown separately and independently for the sake of explanation, the same software or hardware may be used at different timings.

When the configuration of FIG. 4 is applied to a mode in which low bitwidth quantization is performed for each layer of CNN, in order to enable parallel processing of each layer, the bitwidth reducing unit (B100) and the bitwidth re-reducing unit (B102) are included for each layer. The relearning unit (B101) and the external memory (B107) may be common to each layer.

By the process described with reference to FIG. 5, the learned low bitwidth CNN model that is finally output is implemented in hardware configured of a semiconductor device such as an FPGA, as in the conventional CNN. In the low bitwidth CNN model output according to this embodiment, accurate learning is performed, and the weighting factor of each layer is set to a lower bit number than the original model. Therefore, a neural network implemented in hardware can perform calculations with high accuracy and low load, and can operate with low power consumption.

### Second Embodiment

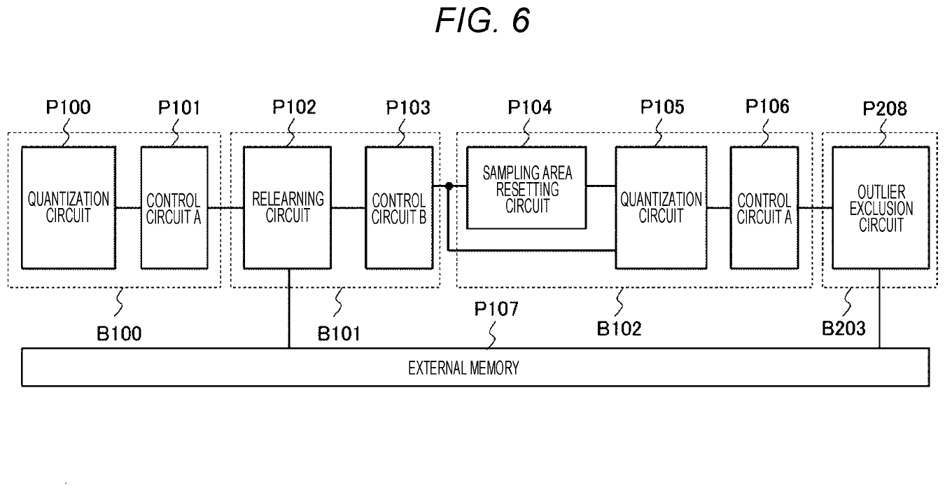

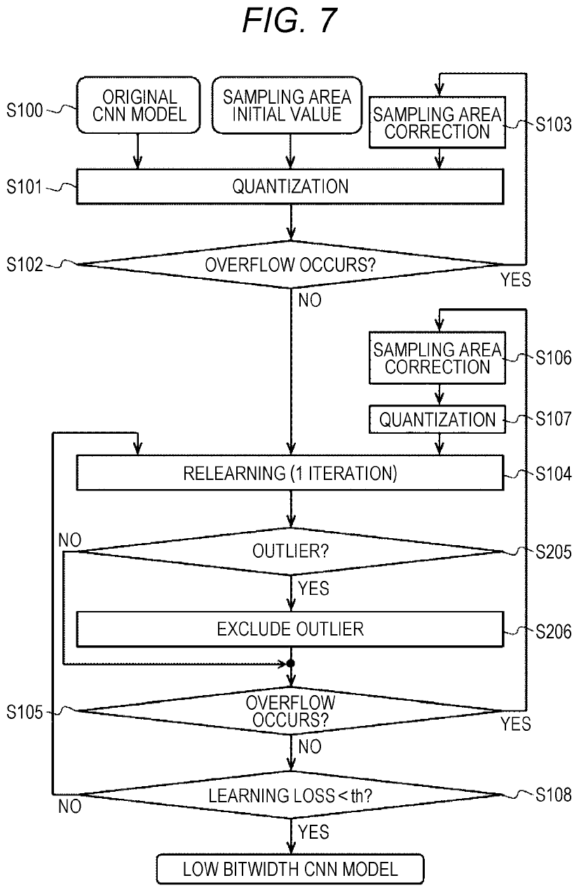

FIGS. 6 and 7 are a configuration diagram and a processing flowchart of the second embodiment, respectively. The same components as those of the first embodiment are denoted by the same reference numerals and the description thereof is omitted. The second embodiment shows an example in which an outlier is considered. The outlier is, for example, a value isolated from the distribution of weighting factors. If the sampling area is always set so as to cover the maximum value and the minimum value of the weighting factor, there is a problem that the quantization efficiency is lowered because the outliers with small appearance frequency are included. Therefore, in the second embodiment, for example, a threshold is set that determines a predetermined range in the plus direction and the minus direction from the median of the distribution of weighting factors, and weighting factors outside the range are ignored as outliers.

The second embodiment shown in FIG. 6 has a configuration in which an outlier exclusion unit (B203) is added to the output unit of FIG. 4 of the first embodiment. The outlier exclusion unit is configured of an outlier exclusion circuit (P208), and when the weighting factor of the low bitwidth CNN model output in the first embodiment exceeds an arbitrary threshold, the corresponding weighting factor is excluded as the outlier. The sampling area is set to cover the maximum and minimum values, ignoring outliers. For example, the threshold is set to the plus side and the minus side from the median of the distribution of the weighting factors, and the weighting factor located on the plus side or the minus side of the threshold is set as an outlier. The threshold may be set to either positive or negative.

An operation based on the flowchart of FIG. 7 will be described. In addition, only the part which has a change from FIG. 5 of the first embodiment is described below. Further, in FIG. 7, step is abbreviated as S.

Step 205: With respect to the low bitwidth CNN model output in the first embodiment, it is determined whether the value of the weighting factor is equal to or more than the arbitrary threshold. If it is equal to or more than the threshold, the process proceeds to step 206, and if it is less than the threshold, the process proceeds to step 207.

Step 206: If it is determined in step 205 that the value of the weighting factor is equal to or more than the threshold, it is excluded as an outlier.

The configuration of FIG. 6 is applied to a mode in which low bitwidth quantization is performed for each layer of CNN, and when parallel processing is performed, the outlier exclusion unit (B203) is provided for each layer.

### Third Embodiment

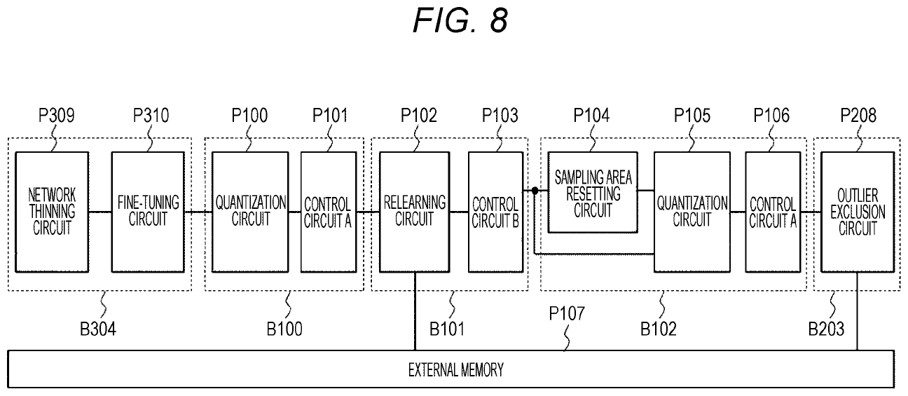

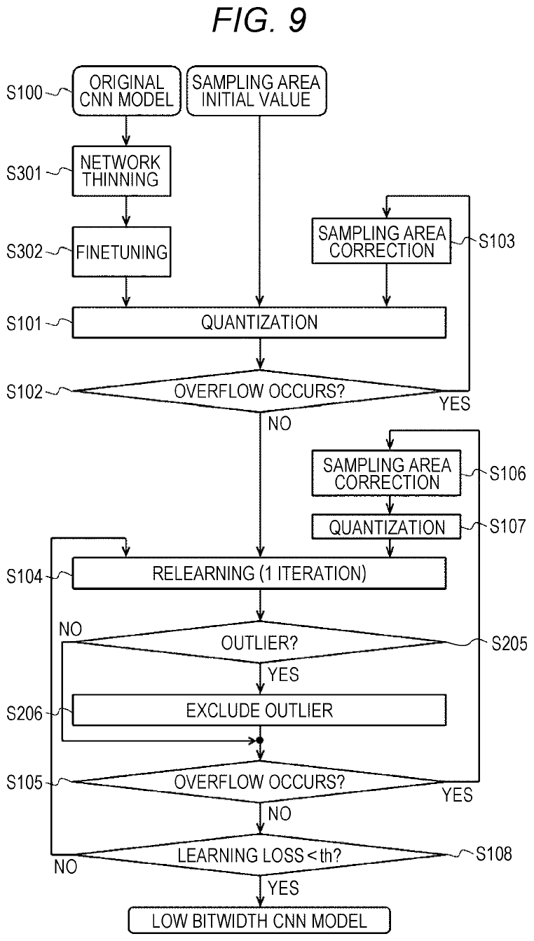

FIGS. 8 and 9 are a configuration diagram and a processing flowchart of the third embodiment, respectively. The same components as those of the first and second embodiments are denoted by the same reference numerals and the description thereof will be omitted.

The third embodiment shown in FIG. 8 has a configuration in which a network (Network) thinning unit (B304) is added to an input unit of the second embodiment. The network thinning unit is composed of a network thinning circuit (B309) and a fine-tuning circuit (B310). In the former circuit, unnecessary neurons in the CNN network are thinned out, and in the latter, fine tuning (transfer learning) is applied to the CNN after thinning. Unnecessary neurons are, for example, neurons with small weighting factors. Fine tuning is a known technique, and is a process of advancing learning faster by acquiring weights from an already trained model.

The operation of the configuration of FIG. 8 will be described based on the flowchart of FIG. 9. Note that, only the part which has a change from the second embodiment is described below. Also, in FIG. 9, step is abbreviated as S.

Step 301: Thinning of unnecessary neurons in the network is performed with respect to the original CNN model before bitwidth reduction.

Step 302: Fine tuning is applied to the thinned-out CNN model.

When the configuration of FIG. 8 is applied to a mode in which low bitwidth quantization is performed for each layer of CNN, the network thinning unit (B304) may be common to each layer.

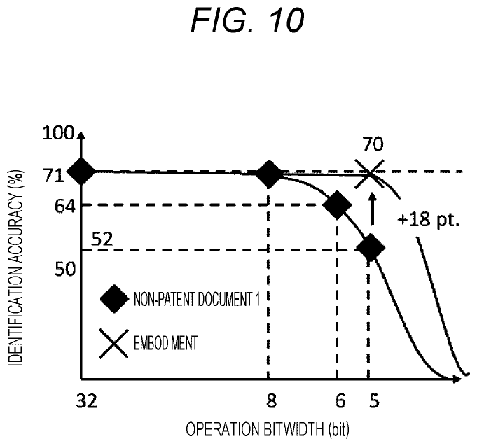

FIG. 10 shows identification accuracy in the case of performing bitwidth reduction by applying the first embodiment to ResNet34, which is a type of identification AI, and in the case of performing bitwidth reduction using Qiu et al. Going Deeper with Embedded FPGA Platform for Convolutional Neural Network, FPGA'16. The operation bit width of 32 bits indicates a continuous value before discretization. By using this embodiment, it is possible to reduce the operation to 5 bits while suppressing the decrease in recognition accuracy.

### Fourth Embodiment

The first to third embodiments have been described by taking the quantization of the weighting factor as an example. Similar quantization can be applied to feature maps that are the input and output of convolution operations. The feature map refers to an object x into which the weighting factor is to be convoluted and a result y into which the weighting factor is convoluted. Here, focusing on a certain layer of the neural network, the input/output is

y=w*x

y: output feature map
(It is the input feature map of the next layer. Output from neural network in case of the last layer.)
w: weighting factor
*: convolution operation
x: input feature map
(It is the output feature map of previous layer. Input to the neural network in case of the first layer). Thus, when the weighting factor changes due to relearning, the output feature map (that is, the input feature map of the next layer) also changes.

Therefore, by discretizing not only the weighting factor but also the object x to be convoluted and the convoluted result y, the calculation load can be further reduced. At this time, as in the case of the quantization of the weighting factors in the first to third embodiments, requantization of the feature map can be performed when there is a change in the distribution of the feature map or when there is an overflow. Alternatively, feature map requantization can be performed unconditionally at each relearning. Further, as in the second embodiment, also in the quantization of the feature map, outlier extrusion processing may be performed. Alternatively, only the feature map may be quantized or requantized without quantization or requantization of the weighting factor. By requantizing both the weighting factor and the feature map, it is possible to obtain the maximum calculation load reduction effect and to suppress the decrease in recognition accuracy due to the overflow.

As in the case of the weighting factor, the quantized feature map is also implemented in the FPGA. In normal operation, it may be assumed that a value of the same number of digits is input in order to input the same information as in learning. For example, in the case of handling an image of a standardized size, an appropriate setting can be made with the same quantization number in learning and in operation. Therefore, the amount of calculation can be effectively reduced.

According to the embodiments described above, it is possible to reduce the weight of the CNN by reducing the bitwidth of calculation and to suppress the information loss due to deviation of the numerical value to be calculated from the sampling area. The CNN learned by the apparatus or method of the embodiment has an equivalent logic circuit implemented in, for example, an FPGA. At this time, since the numerical value to be calculated is appropriately quantized, it is possible to reduce the calculation load while maintaining the calculation accuracy.

What is claimed is:

1. A neural network learning device, comprising a bitwidth reducing unit, a learning unit, and a memory, wherein
the bitwidth reducing unit executes a first quantization that applies a first quantization area to a numerical value to be calculated in a neural network model,
the learning unit performs learning with respect to the neural network model to which the first quantization has been executed,
the bitwidth reducing unit executes a second quantization that applies a second quantization area to a numerical value to be calculated in the neural network model on which learning has been performed in the learning unit, and
the memory stores the neural network model to which the second quantization has been executed.

2. The neural network learning device according to claim 1, wherein the first quantization area and the second quantization area have different ranges.

3. The neural network learning device according to claim 1, wherein
the bitwidth reducing unit includes a first control circuit, and
the first control circuit causes the second quantization to be performed when a change occurs in a distribution of numerical values to be calculated as a result of the learning.

4. The neural network learning device according to claim 1, wherein
the bitwidth reducing unit includes a first control circuit, and
the first control circuit causes the second quantization to be performed when the numerical value to be calculated as a result of the learning overflows from the first quantization region.

5. The neural network learning device according to claim 1, wherein
the bitwidth reducing unit includes a sampling area resetting circuit and a quantization circuit,
the sampling area resetting circuit sets the second quantization area between the minimum value and the maximum value of the numerical values to be calculated in the second quantization, and
the quantization circuit samples the numerical values to be calculated at equal intervals in the second quantization area.

6. The neural network learning device according to claim 1, further comprising an outlier exclusion unit, wherein
the outlier exclusion unit excludes values outside a predetermined range of the numerical value to be calculated,
the bitwidth reducing unit includes a sampling area resetting circuit and a quantization circuit,
the sampling area resetting circuit sets the second quantization area between the minimum value and the maximum value in the predetermined range of the numerical value to be calculated in the second quantization, and
the quantization circuit samples numerical values to be calculated at equal intervals in the second quantization area.

7. The neural network learning device according to claim 1, wherein
the numerical value to be calculated of the neural network model is at least one of a weighting factor and a feature map of a neural network.

8. A neural network learning method which learns a weighting factor of a neural network by an information processing apparatus including a bitwidth reducing unit, a learning unit, and a memory, the method comprising:
a first step of executing, by the bitwidth reducing unit, a first quantization that applies a first quantization area to a weighting factor of an arbitrary neural network model that has been input;
a second step of performing, by the learning unit, learning with respect to the neural network model to which the first quantization has been executed;
a third step of executing, by the bitwidth reducing unit, a second quantization that applies a second quantization area to a weighting factor of the neural network model on which the learning has been performed in the learning unit; and
a fourth step of storing, by the memory, the neural network model to which the second quantization has been executed.

9. The neural network learning method according to claim 8, wherein the first quantization area and the second quantization area have different ranges.

10. The neural network learning method according to claim 8, wherein in the third step, the second quantization is executed when a change occurs in the distribution of weighting factors due to the learning.

11. The neural network learning method according to claim 8, wherein in the third step, the second quantization is executed when a weighting factor overflows from the first quantization area due to the learning.

12. The neural network learning method according to claim 8, wherein in the third step, in the second quantization, the second quantization area is set between the minimum value and the maximum value of the weighting factors of the neural network model, and the weighting factors are sampled at equal intervals in the second quantization area.

13. The neural network learning method according to claim 8, wherein in the third step,
values outside the predetermined range of the weighting factors of the neural network model are excluded, and
in the second quantization, the second quantization area is set between the minimum value and the maximum value within the predetermined range of the weighting factors of the neural network model, and the weighting factors are sampled at equal intervals in the second quantization area.

14. The neural network learning method according to claim 8, wherein in the fourth step,
it is determined whether the learning loss of the neural network model to which the second quantization has been executed is equal to or more than an arbitrary threshold,
when the learning loss is less than the arbitrary threshold, the neural network model to which the second quantization has been executed is stored in the memory, and the process is ended, and
when the learning loss is equal to or more than the arbitrary threshold, relearning is performed by the learning unit on the neural network model to which the second quantization has been executed.

15. The neural network learning method according to claim 14, wherein a neural network is configured in a semiconductor device by use of the neural network model stored in the memory.
